(19) United States
(12) Patent Application Publication
(10) Pub. No.: US 2002/0069049 A1
(43) Pub. Date: Jun. 6, 2002

(54) Dynamic determination of language-specific data output

(76) Inventor: Geoffrey L. Turner, Latham, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/730,987

(22) Filed: Dec. 6, 2000

(51) Int. Cl. G06F 17/20

(52) U.S. Cl. 704/8

(57) ABSTRACT

A language-specific output structure on an output medium, and an associated language database structure, method, and computer system. An algorithm determines a preferred language of the user. Then the algorithm retrieves text in the preferred language from the language database structure, and transfers the text to output zones of the output medium.

### BACKGROUND OF THE INVENTION

1. Technical Field

The present invention relates to a language-specific output structure on an output medium, and an associated language database structure, method, and computer system.

2. Related Art

With increasing globalization of business and trade, it is common practice for a business to establish multiple offices in countries that speak a language different from that of the home office for the business. Additionally, there is a trend to consolidate these remote offices into a single location in which multiple languages are spoken and written by office workers. Such office workers routinely use computers in the course of doing business.

There is a need for computer screens to express text in a language that each office worker can understand.

### SUMMARY OF THE INVENTION

The present invention provides a language database structure, comprising:

a descriptor database structure including at least one descriptor, at least one descriptor value for each descriptor wherein each descriptor value is expressed in a language, and a language identifier for each descriptor value wherein the language identifier identifies the language.

The present invention provides a method of generating a language-specific output structure on an output medium, comprising the steps of:

providing a descriptor database structure including at least one descriptor, at least one descriptor value for each descriptor wherein each descriptor value is expressed in a language, and a language identifier for each descriptor value wherein the language identifier identifies the language;

determining a user identifier of a user;

identifying a preferred language based on the user identifier;

determining at least one output descriptor and associating with each output descriptor an output zone of the output medium, wherein each output descriptor appears as a descriptor within the descriptor database structure;

generating a descriptor value for each output descriptor, by utilizing the preferred language and the descriptor database structure; and

transferring the descriptor value for each output descriptor to the associated output zone of the output medium.

The present invention provides a language-specific output structure, comprising an output medium and descriptor values on the output medium, wherein the descriptor values are placed on the output medium by a process comprising the steps of:

providing a descriptor database structure including at least one descriptor, at least one descriptor value for each descriptor wherein each descriptor value is expressed in a language, and a language identifier for each descriptor value wherein the language identifier identifies the language;

determining a user identifier of a user;

identifying a preferred language based on the user identifier;

determining at least one output descriptor and associating with each output descriptor an output zone of the output medium, wherein each output descriptor appears as a descriptor within the descriptor database structure;

generating a descriptor value for each output descriptor, by utilizing the preferred language and the descriptor database structure; and

transferring the descriptor value for each output descriptor to the associated output zone of the output medium.

The present invention provides a computer system for generating a language-specific output structure on an output medium, comprising:

a processor;

a memory device;

an input device coupled to the processor;

an output device coupled to the processor;

a language database structure coupled to the processor; and

a computer code located on the memory device,

wherein the output device includes the output medium,

wherein the processor executes the computer code,

wherein the language database structure includes a descriptor database structure,

wherein the descriptor database structure includes at least one descriptor, at least one descriptor value for each descriptor such that each descriptor value is expressed in a language, and a language identifier for each descriptor value such that the language identifier identifies the language, and

wherein the computer code comprises an algorithm which includes:

determining a user identifier of a user;

identifying a preferred language based on the user identifier;

determining at least one output descriptor and associating with each output descriptor an output zone of the output medium, wherein each output descriptor appears as a descriptor within the descriptor database structure;

generating a descriptor value for each output descriptor, by utilizing the preferred language and the descriptor database structure; and

transferring the descriptor value for each output descriptor to the associated output zone of the output medium.

The present invention provides a computer program product, comprising:

a computer usable medium having a computer readable program code embodied therein for generating a language-specific output structure on an output medium,

wherein the computer readable program code comprises an algorithm which utilizes a language database structure,

wherein the language database structure includes a descriptor database structure,

wherein the descriptor database structure includes at least one descriptor, at least one descriptor value for each descriptor such that each descriptor value is expressed in a language, and a language identifier for each descriptor value such that the language identifier identifies the language, and

wherein the algorithm includes:

determining a user identifier of a user;

identifying a preferred language based on the user identifier;

determining at least one output descriptor and associating with each output descriptor an output zone of the output medium, wherein each output descriptor appears as a descriptor within the descriptor database structure;

generating a descriptor value for each output descriptor, by utilizing the preferred language and the descriptor database structure; and

transferring the descriptor value for each output descriptor to the associated output zone of the output medium.

The present invention enables computer screens to express text in a language that each office worker can understand.

### BRIEF DESCRIPTION OF THE DRAWINGS

FIG. 1 depicts a template of a computer screen layout comprising descriptors in output zones of the data screen, in accordance with embodiments of the present invention.

FIG. 2 depicts a descriptor database structure including the descriptors of FIG. 1, associated descriptor values, and a language identifier for each descriptor value.

FIG. 3 depicts a computer screen output structure with inserted descriptor values in accordance with the template of FIG. 1, wherein the inserted descriptor values are expressed in English.

FIG. 4 depicts a computer screen output structure with inserted descriptor values in accordance with the template of FIG. 1, wherein the inserted descriptor values are expressed in German.

FIG. 5 depicts a user database structure used in conjunction with the descriptor database structure of FIG. 2.

FIG. 6 depicts a replacement language database structure used in conjunction with the descriptor database structure of FIG. 2.

FIG. 7 depicts an application database structure used in conjunction with the descriptor database structure of FIG. 2.

FIG. 8 is a flow chart of a method for generating a language-specific output structure on an output medium, in accordance with embodiments of the present invention.

FIG. 9 depicts a computer system for generating a language-specific output structure on an output medium, in accordance with embodiments of the present invention.

### DETAILED DESCRIPTION OF THE INVENTION

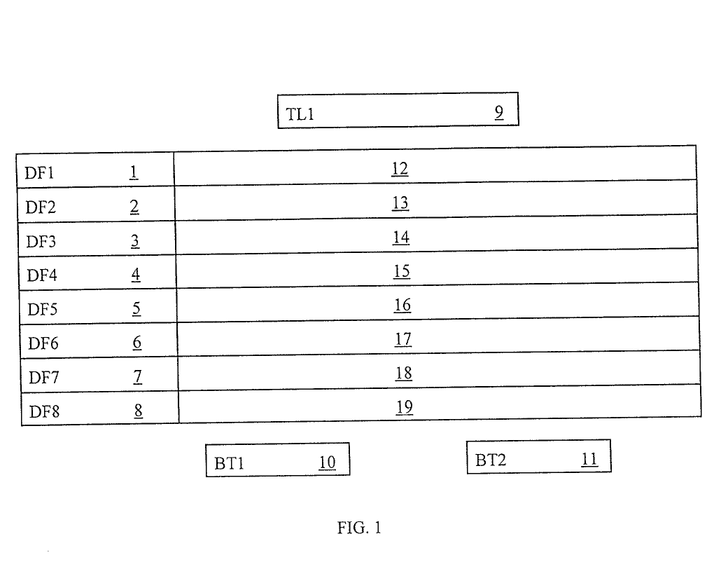

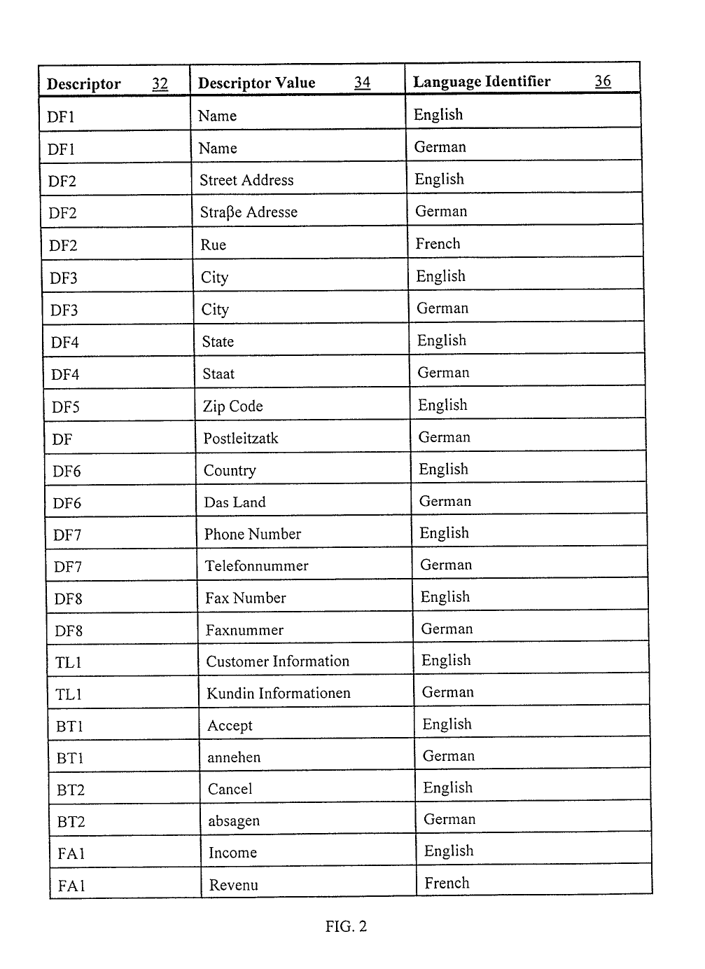

FIG. 1 illustrates a template of a computer screen layout 20 comprising descriptors DF1, DF2, DF3, DF4, DF5, DF6, DF7, and DF8, TL1, BT1, and BT2 in output zones 1-11, respectively, of a data screen, in accordance with embodiments of the present invention. A descriptor identifies text which can be expressed in different languages. Thus, as shown in FIG. 2, the descriptor DF2 identifies the text “Street Address” in English, “Straβe Adresse” in German, and “Rue” in French. Returning to FIG. 1, the output zones 1-11 are spatial portions of a computer screen as shown in FIG. 1. Inasmuch as the present invention is applicable to other output media than a computer screen (e.g., a printed page generated by a printer), output zones generally pertain to spatial portions of an output medium. The output zones 12-19 in FIG. 1 are spaces into which a user is expected to enter information relating to the descriptors DF1, DF2, DF3, DF4, DF5, DF6, DF7, and DF8, respectively. A user is defined as a user of any database structure of the present invention or of any computer, computer system, or computer software which implements any aspect of the present invention.

FIG. 2 illustrates a descriptor database structure 30, in the form of a table, including descriptors in a Descriptor column 32, associated descriptor values in a Descriptor Value column 34, and associated language identifiers in a Language Identifier column 36, in accordance with embodiments of the present invention. FIG. 2 identifies descriptors and their associated descriptor values in various languages, and generally identifies more descriptors than appear in the template of the computer screen layout 20 of FIG. 1. The descriptor database structure 30 of FIG. 2 is not specific to the computer screen layout 20 of FIG. 1 and is generally applicable to many different computer screen layouts in addition to the screen layout 20 of FIG. 1. For example, the descriptor database structure 30 of FIG. 2 includes the descriptor FA1 which does not appear in the computer screen layout 20 of FIG. 1, but may appear in a computer screen layout other than the computer screen layout 20 of FIG. 1.

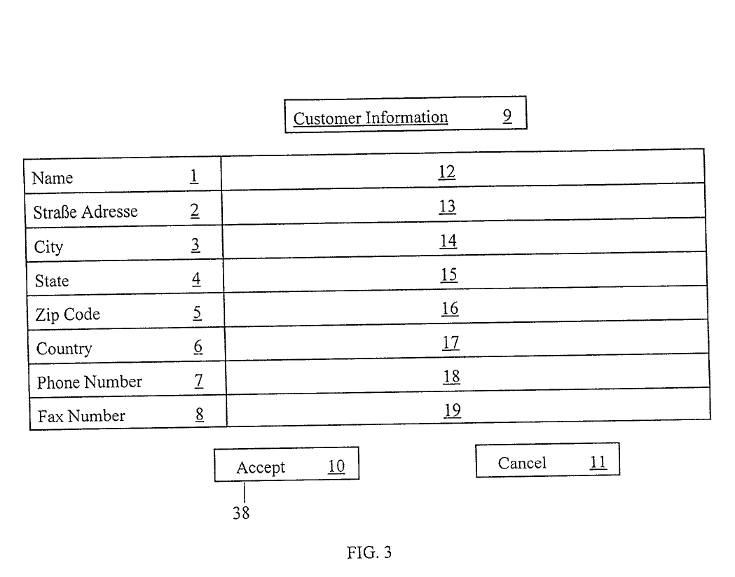

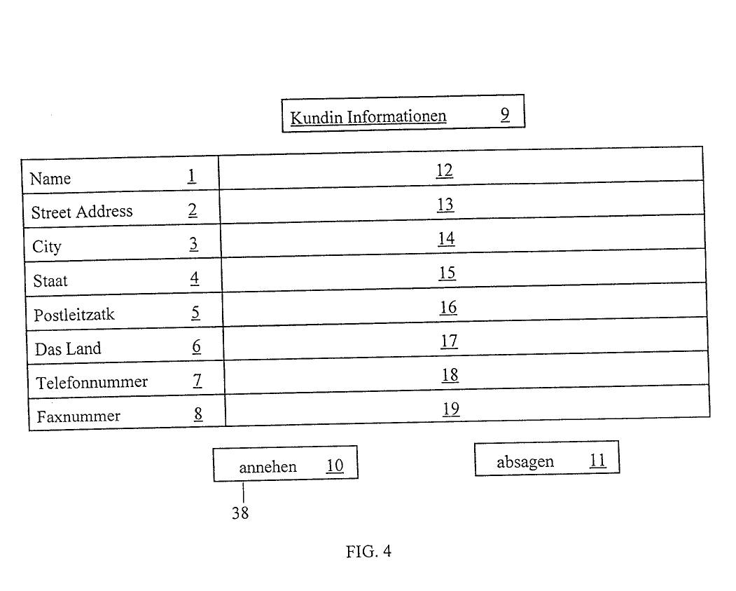

Upon identification of a language, the information in the descriptor database structure 30 may be used to generate a computer screen output structure as exemplified in FIGS. 3 and 4. FIG. 3 illustrates an English computer screen output structure 41 with inserted descriptor values in English of descriptors shown in FIG. 2, in accordance with the template of the computer screen layout 20 of FIG. 1. The descriptor values in FIG. 3 have been extracted from FIG. 2 for descriptor values expressed in English. Similarly, FIG. 4 illustrates a German computer screen output structure 42 with inserted descriptor values in German of descriptors shown in FIG. 2, in accordance with the screen layout 20 of FIG. 1. The descriptor values in FIG. 4 have been extracted from FIG. 2 for descriptor values expressed in German.

The Descriptor column 32 in the descriptor database structure 30 of FIG. 2 identifies one or more descriptors. A descriptor comprises one or more ASCII characters, and a “blank” ASCII character within a descriptor is permissible. Each descriptor within the Descriptor column 32 must be unique.

The Descriptor Value column 34 in the descriptor database structure 30 of FIG. 2 identifies one or more descriptor values associated with each descriptor in the Descriptor column 32. Each descriptor value appears in the Descriptor Value column 34 and is expressed in a language identified in the Language Identifier column 36. While the descriptors relate to a screen layout, such as the computer screen layout 20 of FIG. 1, the descriptor values explicitly appear in a computer screen output structure such as the computer screen output structures 41 and 42 of FIGS. 3 and 4, respectively. A number of descriptor values may be the same for each descriptor, or may vary. In FIG. 2, the number of descriptor values varies. For example, the descriptor BT1 has two values (Accept, annehen), while the descriptor DF2 has three descriptor values (Street Address, Straβe Adresse, Rue). For cases in which the number of descriptor values is the same for each descriptor, the descriptor values of each descriptor may be expressed in the same language, or in different languages.

The Language Identifier column 36 in the descriptor database structure 30 of FIG. 2 identifies, directly or impliedly, languages associated with corresponding descriptor values of the Descriptor Value column 34. For example, the descriptor DF7 has a descriptor value of Phone Number in English, and a descriptor value of Telefonnummer in German. Although each language identifier in the Language Identifier column 36 is expressed as an actual name of the language (e.g., English, German, French), the language identifier may alternatively be any language symbol which is understood by processing software of the present invention as standing for a particular language. For example, English, German, and French could be expressed in the Language Identifier column 36 as 501, 502, and 503, if the processing software understands 501, 502, and 503 as standing for English, German, and French, respectively. Another alternative is to use language pointers. For example, the Language Identifier column 36 could include memory addresses (or pointers to memory addresses) wherein said memory addresses would include actual language symbols (e.g., English, German, French) or text standing for languages (e.g., 501, 502, 503). Thus, a language pointer is said to point to a language by pointing to a memory address which includes the language symbol or which includes text standing for the language.

FIG. 2 shows an embodiment of the descriptor database structure 30 in which the descriptors, descriptor values, and language identifiers are stored in a single table. Alternatively, the descriptors, descriptor values, and language identifiers could be stored in multiple tables. For example, the descriptors and descriptor values could be stored in a first table, and the descriptor values and language identifiers could be stored in a second table. As another example, the descriptors and descriptor values could be stored in a first table, and the descriptor values for each language couple be stored in a language-specific table whose name includes the language identifier. For example, a language-specific table, named “German Descriptor Values,” would includes German descriptor values only and would not include a descriptor of any language other than German.

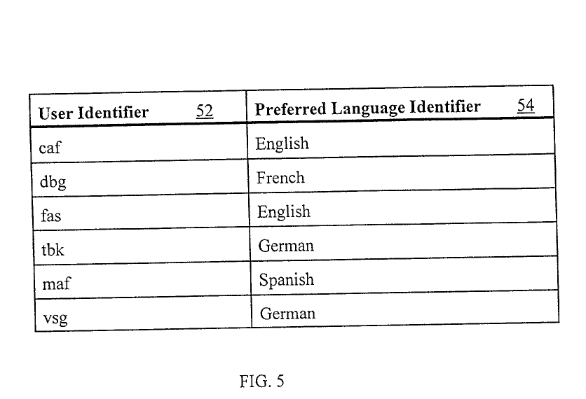

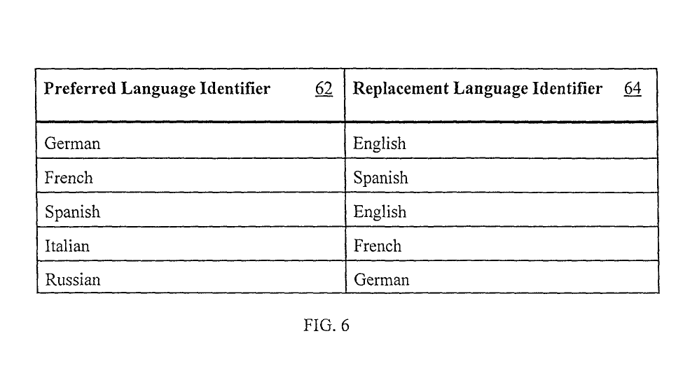

In generating the computer screen output structures 41 and 42 of FIGS. 3 and 4, respectively, in accordance with the computer screen layout 20 of FIG. 1 and the descriptor database structure 30 of FIG. 2, two other database structures may be utilized, namely a user database structure 50 of FIG. 5 and an application database structure 60 of FIG. 6.

The user database structure 50 of FIG. 5 serves to determines the user's preferred language which is the language to be used in conjunction with the descriptor database structure 30 of FIG. 2. The user database structure 50 of FIG. 5 comprises a User Identifier column 52 and a Preferred Language Identifier column 54. The user identifier of the user appearing in the User Identifier column 52 is known to the processing software of the present invention, such as, inter alia, from a login by the user or from prompting the user for information from which the user identifier may be ascertained. The Preferred Language Identifier column 54 identifies the user's preferred language. The preferred language in the Preferred Language Identifier column 54 may be a preferred language name or a preferred language symbol which is understood by the processing software of the present invention as standing for a particular language. For example, English, French German, and Spanish could be expressed in the Preferred Language Identifier column 54 as 601, 602, 603, and 604, if the processing software understands 601, 602, 603, and 604 as standing for English, French German, and Spanish, respectively. Another alternative is to use language pointers. For example, the Preferred Language Identifier column 54 could include memory addresses (or pointers to memory addresses) which point to the preferred language; i.e., said memory addresses could include actual language symbols (e.g., English, French German, Spanish) or text standing for languages (e.g., 601, 602, 603, 604). Thus as stated supra, a language pointer is said to point to a language by pointing to a memory address which includes the language symbol or which includes text standing for the language. As another alternative, the language pointer could point to an algorithm which executes program steps that determine the preferred language (e.g., the algorithm could base the preferred language determination on stored information about the user such as, inter alia, citizenship information or country of birth information). A language pointer is said to point to an algorithm by pointing to a memory address at which the algorithm, or a portion thereof, is located.

An alternative to using the database structure 50 of FIG. 5 for determining the user's preferred language is to query the user directly (such as by prompts) for the user's preferred language or preferred language symbol. Since the query must itself be expressed in a language, this alternative is not practical if the user cannot understand the query because the user does not know the language in which the query has been expressed. In practice, however, all that the user would have to understand is the query itself even if the user does not know the language in which the query has been expressed. Since the query may be used repeatedly, the user can become familiar with the query with repeated use even if the user does not know the language in which the query has been expressed.

The preceding discussion indicates how the user's preferred language can be determined. Nonetheless, there may be a descriptor in the computer screen layout 20 of FIG. 1 not having a descriptor value expressed in the user's preferred language (e.g., not having a descriptor value in the language database structure 30 of FIG. 2). To deal with this situation, FIG. 6 illustrates a replacement language database structure 60, which comprises a Preferred Language Identifier column 62 and a Replacement Language Identifier 64. The Preferred Language Identifier column 62 includes preferred languages, and the Replacement Language Identifier 64 includes replacement languages which serves as replacements for the corresponding preferred languages. Thus, the replacement language database structure 60 expresses the replacement language as a function of the preferred language. The replacement language is used as a substitute for the preferred language when a descriptor does not have a descriptor value in the user's preferred language, such that the descriptor value is needed for generating a language-specific output structure (e.g., the computer screen output structures 41 and 42 of FIGS. 3 and 4, respectively).

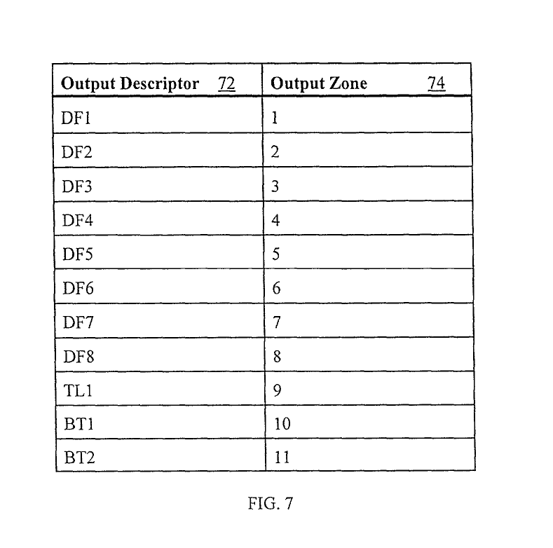

The application database structure 70 of FIG. 7 is used to identify output zones in which descriptor values are to be placed. The application database structure 60 comprises an Output Descriptor column 72 and an Output Zone column 74. The Output Descriptor column 72 includes output descriptors whose descriptor values in the user's preferred language are to be placed in the corresponding output zone of the Output Zone column 74. The output descriptors in the Output Descriptor column 72 should be included in the Descriptor 32 column of the descriptor database structure 30 of FIG. 2. Thus the application database structure 70 defines the computer screen layout 20 of FIG. 1. An output descriptor may include, inter alia, a screen title, a prompt, a help text, an error message, an instructional message, and an informational message.

Alternatives to the application database structure 70 of FIG. 7 exist. For example, output zones for descriptors may be hard-wired into a computer code which generates the language-specific output structure on the output medium. As another example, output zones for descriptors may be dynamically computed by the aforementioned computer code to account for variable output structures based on a variable number of descriptors.

The output medium may include any computer output medium such as, inter alia, a screen display of a computer monitor or a printed page generated by a printer. If the output medium includes a screen display, then each output zone identifies a portion of the screen display. If the output medium includes a printed page, then each output zone identifies a portion of the printed page.

The various database structures described herein are portions of an overall database structure, called a language database structure. Thus, the language database structure may comprise, inter alia, the descriptor database structure 30 of FIG. 2, the user database structure 50 of FIG. 5, the replacement language database structure 60 of FIG. 6, and the application database structure 70 of FIG. 7.

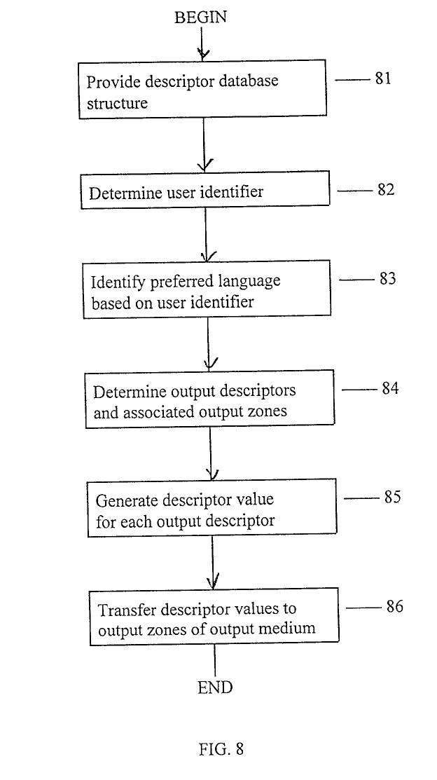

FIG. 8 is a flow chart of a method 80 for generating a language-specific output structure on an output medium, in accordance with embodiments of the present invention. The method 80 comprises steps 81-86 as shown. Step 81 provides a descriptor database structure such as, inter alia, the descriptor database structure 30 described supra in conjunction with FIG. 2. Step 82 determines a user identifier such as, inter alia, by utilizing login information relating to the user or by prompting the user for information from which the user identifier may be ascertained. Step 83 identifies a preferred language such as, inter alia, by querying the user or by utilizing the user database structure 50 described supra in conjunction with FIG. 5. Step 84 determines output descriptors and associated output zones, such as, inter alia: by utilizing an application database structure such as the application database structure 70 described supra in conjunction with FIG. 7; by utilizing a hard-wiring of output zones within a computer code which generates the language-specific output structure; or by having the computer code dynamically compute output zones for the output descriptors. Step 85 generates a descriptor value for each output descriptor such as, inter alia, by utilizing the preferred language in conjunction with the descriptor database structure, as discussed supra. Step 86 transfers the descriptor values to output zones of the output medium. The method 80 may be incorporated within an algorithm of a computer code.

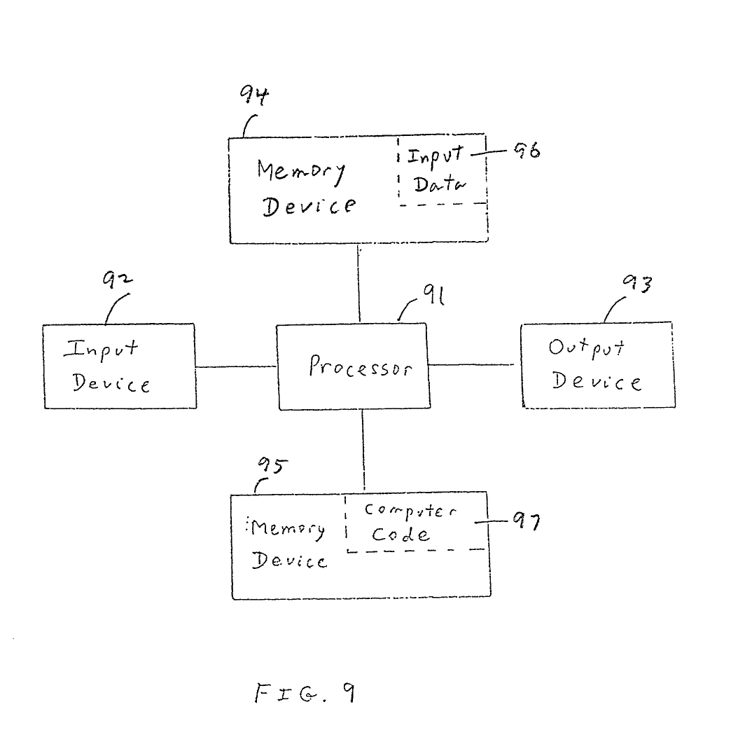

FIG. 9 illustrates a computer system 90 for generating a language-specific output structure on an output medium, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a dynamic random access memory (DRAM), a read-only memory (ROM), etc. The memory device 95 includes a computer code 97. The computer code 97 includes an algorithm for generating the language-specific output structure on the output medium. The processor 91 executes the computer code 97. The memory device 94 includes input data 96. The input data 96 includes input required by the computer code 97. The output device 93 displays output from the computer code 97. In particular, the output device 93 includes the output medium and displays the output structure of the present invention on the output medium.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

The present invention includes the various database structures discussed supra (e.g., the descriptor database structure 30 of FIG. 2, the user database structure 50 of FIG. 5, the replacement language database structure 60 of FIG. 6, and the application database structure 70 of FIG. 7). Such database structures comprise databases in any form or any data structures having database functionality that is relevant to the present invention. Such database structures comprise, inter alia, relational databases, non-relational databases, spreadsheets, data structures within computer codes, data files formatted as tables, etc.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

we claim:

1. A language database structure, comprising:
a descriptor database structure including at least one descriptor, at least one descriptor value for each descriptor wherein each descriptor value is expressed in a language, and a language identifier for each descriptor value wherein the language identifier identifies the language.

2. The language database structure of claim 1, wherein the language identifier is selected from the group consisting of a language name and a language symbol.

3. The language database structure of claim 1, wherein the language identifier is a language pointer.

4. The language database structure of claim 1, wherein a first descriptor of the at least one descriptor has N₁ descriptor values, wherein a second descriptor of the at least one descriptor has N₂ descriptor values, and wherein N₁ is unequal to N₂.

5. The language database structure of claim 1, wherein the at least one descriptor, the at least one descriptor value for each descriptor, and the language identifier for each descriptor value are stored in a table.

6. The language database structure of claim 1, wherein the at least one descriptor and the at least one descriptor value for each descriptor are stored in a first table, and wherein the at least one descriptor value for each descriptor and the language identifier for each descriptor value are stored in a second table.

7. The language database structure of claim 1, wherein the descriptor database structure comprises a table having a name that includes the language identifier, wherein descriptors and associated descriptor values expressed in the language are stored in the table, and wherein the table does not include a descriptor value expressed in another language that differs from the language.

8. The language database structure of claim 1, further comprising a user database structure including at least one user identifier which identifies a user, and a preferred language identifier which identifies a preferred language of the user.

9. The language database structure of claim 8, wherein the preferred language identifier is selected from the group consisting of a preferred language name and a preferred language symbol.

10. The language database structure of claim 8, wherein the preferred language identifier is a preferred language pointer.

11. The language database structure of claim 10, wherein the preferred language pointer points to the preferred language.

12. The language database structure of claim 10, wherein the preferred language pointer points to an algorithm which executes program steps that determines the preferred language.

13. The language database structure of claim 8, further comprising a replacement language database structure, wherein the replacement language database structure expresses a replacement language as a function of the preferred language.

14. The language database structure of claim 1, further comprising an application database structure which includes:
at least one output descriptor, wherein each output descriptor appears as a descriptor within the descriptor database structure; and
an output zone of an output medium associated with each output descriptor.

15. The language database structure of claim 14, wherein the output medium includes a screen display, and wherein each output zone identifies a portion of the screen display.

16. The language database structure of claim 15, wherein each output descriptor is of an output type selected from the group consisting of a screen title, a prompt, a help text, an error message, an instruction message, and an informational message.

17. The language database structure of claim 14, wherein the output medium includes a printed page, and wherein each output zone identifies a portion of the printed page.

18. A method of generating a language-specific output structure on an output medium, comprising the steps of:
providing a descriptor database structure including at least one descriptor, at least one descriptor value for each descriptor wherein each descriptor value is expressed in a language, and a language identifier for each descriptor value wherein the language identifier identifies the language;
determining a user identifier of a user;
identifying a preferred language based on the user identifier;
determining at least one output descriptor and associating with each output descriptor an output zone of the output medium, wherein each output descriptor appears as a descriptor within the descriptor database structure;
generating a descriptor value for each output descriptor, by utilizing the preferred language and the descriptor database structure; and
transferring the descriptor value for each output descriptor to the associated output zone of the output medium.

19. The method of claim 18, wherein the language identifier is selected from the group consisting of a language name and a language symbol.

20. The method of claim 18, wherein the language identifier is a language pointer.

21. The method of claim 18, wherein a first descriptor of the at least one descriptor has N₁ descriptor values, wherein a second descriptor of the at least one descriptor has N₂ descriptor values, and wherein N₁ is unequal to N₂.

22. The method of claim 18, wherein the step of providing a descriptor database structure comprises providing a table which includes the at least one descriptor, the at least one descriptor value for each descriptor, and the language identifier for each descriptor value.

23. The method of claim 18, wherein the step of providing a descriptor database structure comprises:
providing a first table which includes the at least one descriptor and the at least one descriptor value for each descriptor; and
providing a second table which includes the at least one descriptor value for each descriptor and the language identifier for each descriptor value.

24. The method of claim 18, wherein the step of providing a descriptor database structure comprises providing a table having a name that includes the language identifier, wherein the table includes the descriptors and the associated descriptor values which are expressed in the language, and wherein the table does not include a descriptor value expressed in another language that differs from the language.

25. The method of claim 18, wherein the step of determining a user identifier includes prompting the user for information from which the user identifier may be ascertained.

26. The method of claim 18, wherein the step of identifying a preferred language comprises identifying a preferred language identifier from a user database structure, said preferred language identifier being used to identify the preferred language, and said user database structure including:
a list of user identifiers, said list including the user identifier of the user; and
a preferred language identifier associated with each user identifier.

27. The method of claim 26, wherein the preferred language identifier is selected from the group consisting of a preferred language name and a preferred language symbol.

28. The method of claim 26, wherein the preferred language identifier includes a preferred language pointer.

29. The method of claim 28, wherein the preferred language pointer points to the preferred language.

30. The method of claim 28, wherein the preferred language pointer points to an algorithm which executes program steps that determines the preferred language.

31. The method of claim 26, further comprising providing a replacement language database structure, said replacement language database structure expressing a replacement language as a function of the preferred language.

32. The method of claim 18, wherein the step of determining at least one output descriptor and associating with each output descriptor an output zone of the output medium comprises providing an application database structure which includes:
the at least one output descriptor, wherein each output descriptor appears as a descriptor within the descriptor database structure; and
the output zone of the output medium associated with each output descriptor.

33. The method of claim 18, wherein the output medium includes a screen display, and wherein each output zone identifies a portion of the screen display.

34. The method of claim 33, wherein each output descriptor is of an output type selected from the group consisting of a screen title, a prompt, a help text, an error message, an instructional message, and an information message.

35. The method of claim 18, wherein the output medium includes a printed page, and wherein each output zone identifies a portion of the printed page.

36. A language-specific output structure, comprising an output medium and descriptor values on the output medium, wherein the descriptor values are placed on the output medium by a process comprising the steps of:
providing a descriptor database structure including at least one descriptor, at least one descriptor value for each descriptor wherein each descriptor value is expressed in a language, and a language identifier for each descriptor value wherein the language identifier identifies the language;
determining a user identifier of a user;
identifying a preferred language based on the user identifier;
determining at least one output descriptor and associating with each output descriptor an output zone of the output medium, wherein each output descriptor appears as a descriptor within the descriptor database structure;
generating a descriptor value for each output descriptor, by utilizing the preferred language and the descriptor database structure; and
transferring the descriptor value for each output descriptor to the associated output zone of the output medium.

37. The output structure of claim 36, wherein the language identifier is selected from the group consisting of a language name and a language symbol.

38. The output structure of claim 36, wherein the language identifier is a language pointer.

39. The output structure of claim 36, wherein a first descriptor of the at least one descriptor has N₁ descriptor values, wherein a second descriptor of the at least one descriptor has N₂ descriptor values, and wherein N₁ is unequal to N₂.

40. The output structure of claim 36, wherein providing a descriptor database structure comprises providing a table which includes the at least one descriptor, the at least one descriptor value for each descriptor, and the language identifier for each descriptor value.

41. The output structure of claim 36, wherein providing a descriptor database structure comprises:
providing a first table which includes the at least one descriptor and the at least one descriptor value for each descriptor; and
providing a second table which includes the at least one descriptor value for each descriptor and the language identifier for each descriptor value.

42. The output structure of claim 36, wherein providing a descriptor database structure comprises providing a table having a name that includes the language identifier, wherein the table includes the descriptors and the associated descriptor values which are expressed in the language, and wherein the table does not include a descriptor value expressed in another language that differs from the language.

43. The output structure of claim 36, wherein determining a user identifier includes prompting the user for information from which the user identifier may be ascertained.

44. The output structure of claim 36, wherein identifying a preferred language comprises identifying a preferred language identifier from a user database structure, said preferred language identifier being used to identify the preferred language, and said user database structure including:
a list of user identifiers, said list including the user identifier of the user; and
a preferred language identifier associated with each user identifier.

45. The output structure of claim 44, wherein the preferred language identifier is selected from the group consisting of a preferred language name and a preferred language symbol.

46. The output structure of claim 44, wherein the preferred language identifier includes a preferred language pointer.

47. The output structure of claim 46, wherein the preferred language pointer points to the preferred language.

48. The output structure of claim 46, wherein the preferred language pointer points to an algorithm which executes program steps that determines the preferred language.

49. The output structure of claim 44, wherein the process further comprises providing a replacement language database structure, said replacement language database structure expressing a replacement language as a function of the preferred language.

50. The output structure of claim 36, wherein determining at least one output descriptor and associating with each output descriptor an output zone of the output medium comprises providing an application database structure which includes:
the at least one output descriptor, wherein each output descriptor appears as a descriptor within the descriptor database structure; and
the output zone of the output medium associated with each output descriptor.

51. The output structure of claim 36, wherein the output medium includes a screen display, and wherein each output zone identifies a portion of the screen display.

52. The output structure of claim 51, wherein each output descriptor is of an output type selected from the group consisting of a screen title, a prompt, a help text, an error message, an instructional message, and an information message.

53. The output structure of claim 36, wherein the output medium includes a printed page, and wherein each output zone identifies a portion of the printed page.

54. A computer system for generating a language-specific output structure on an output medium, comprising:
a processor;
a memory device;
an input device coupled to the processor;
an output device coupled to the processor;
a language database structure coupled to the processor; and
a computer code located on the memory device,
wherein the output device includes the output medium,
wherein the processor executes the computer code,
wherein the language database structure includes a descriptor database structure,
wherein the descriptor database structure includes at least one descriptor, at least one descriptor value for each descriptor such that each descriptor value is expressed in a language, and a language identifier for each descriptor value such that the language identifier identifies the language, and
wherein the computer code comprises an algorithm which includes:
determining a user identifier of a user;
identifying a preferred language based on the user identifier;
determining at least one output descriptor and associating with each output descriptor an output zone of the output medium, wherein each output descriptor appears as a descriptor within the descriptor database structure;
generating a descriptor value for each output descriptor, by utilizing the preferred language and the descriptor database structure; and
transferring the descriptor value for each output descriptor to the associated output zone of the output medium.

55. The computer system of claim 54, wherein the language identifier is selected from the group consisting of a language name and a language symbol.

56. The computer system of claim 54, wherein the language identifier is a language pointer.

57. The computer system of claim 54, wherein a first descriptor of the at least one descriptor has N₁ descriptor values, wherein a second descriptor of the at least one descriptor has N₂ descriptor values, and wherein N₁ is unequal to N₂.

58. The computer system of claim 54, wherein the at least one descriptor, the at least one descriptor value for each descriptor, and the language identifier for each descriptor value are stored in a table.

59. The computer system of claim 54, wherein the at least one descriptor and the at least one descriptor value for each descriptor are stored in a first table, and wherein the at least one descriptor value for each descriptor and the language identifier for each descriptor value are stored in a second table.

60. The computer system of claim 54, wherein the descriptor database structure comprises a table having a name that includes the language identifier, wherein descriptors and associated descriptor values expressed in the language are stored in the table, and wherein the table does not include a descriptor value expressed in another language that differs from the language.

61. The computer system of claim 54, wherein determining a user identifier includes prompting the user for information from which the user identifier may be ascertained.

62. The computer system of claim 54, wherein the language database structure further includes a user database structure, wherein identifying a preferred language comprises identifying a preferred language identifier from the user database structure, said preferred language identifier being used to identify the preferred language, and said user database structure including:
a list of user identifiers, said list including the user identifier of the user; and
a preferred language identifier associated with each user identifier.

63. The computer system of claim 62, wherein the preferred language identifier is selected from the group consisting of a preferred language name and a preferred language symbol.

64. The computer system of claim 62, wherein the preferred language identifier in the user database structure includes a preferred language pointer.

65. The computer system of claim 64, wherein the preferred language pointer points to the preferred language.

66. The computer system of claim 64, wherein the preferred language pointer points to an algorithm which executes program steps that determines the preferred language.

67. The computer system of claim 62, wherein the language database structure further includes a replacement language database structure, said replacement language database structure expressing a replacement language as a function of the preferred language.

68. The computer system of claim 54, wherein the language database structure further includes an application database structure, wherein determining at least one output descriptor and associating with each output descriptor an output zone of the output medium comprises accessing the application database structure, and wherein the application database structure includes:
the at least one output descriptor, wherein each output descriptor appears as a descriptor within the descriptor database structure; and
the output zone of the output medium associated with each output descriptor.

69. The computer system of claim 54, wherein the output medium includes a screen display, and wherein each output zone identifies a portion of the screen display.

70. The computer system of claim 69, wherein each output descriptor is of an output type selected from the group consisting of a screen title, a prompt, a help text, an error message, an instructional message, and an information message.

71. The computer system of claim 54, wherein the output medium includes a printed page, and wherein each output zone identifies a portion of the printed page.

72. A computer program product, comprising:
a computer usable medium having a computer readable program code embodied therein for generating a language-specific output structure on an output medium,
wherein the computer readable program code comprises an algorithm which utilizes a language database structure,
wherein the language database structure includes a descriptor database structure,
wherein the descriptor database structure includes at least one descriptor, at least one descriptor value for each descriptor such that each descriptor value is expressed in a language, and a language identifier for each descriptor value such that the language identifier identifies the language, and
wherein the algorithm includes:
determining a user identifier of a user;
identifying a preferred language based on the user identifier;
determining at least one output descriptor and associating with each output descriptor an output zone of the output medium, wherein each output descriptor appears as a descriptor within the descriptor database structure;
generating a descriptor value for each output descriptor, by utilizing the preferred language and the descriptor database structure; and
transferring the descriptor value for each output descriptor to the associated output zone of the output medium.

73. The computer program product of claim 72, wherein the language database structure further includes a user database structure, wherein identifying a preferred language comprises identifying a preferred language identifier from the user database structure, said preferred language identifier being used to identify the preferred language, and said user database structure including:
a list of user identifiers, said list including the user identifier of the user; and
a preferred language identifier associated with each user identifier.

74. The computer program product of claim 72, wherein the language database structure further includes an application database structure, wherein determining at least one output descriptor and associating with each output descriptor an output zone of the output medium comprises accessing the application database structure, and wherein the application database structure includes:
the at least one output descriptor, wherein each output descriptor appears as a descriptor within the descriptor database structure; and
the output zone of the output medium associated with each output descriptor.
